(19) United States
(12) Patent Application Publication
(10) Pub. No.: US 2007/0125407 A1
(43) Pub. Date: Jun. 7, 2007

(54) Jet stream cleaning apparatus

(76) Inventor: Mei-Hua Chen, Chung-Li City (TW)

Correspondence Address: LADAS & PARRY, 5670 WILSHIRE BOULEVARD, SUITE 2100, LOS ANGELES, CA, 90036-5679, US

(21) Appl. No.: 11/291,404

(22) Filed: Dec. 1, 2005

(51) Int. Cl. B08B 3/02

(52) U.S. Cl. 134/166 R; 134/169 R; 134/198; 134/167 R; 239/526

(57) ABSTRACT

A jet stream cleaning apparatus includes a housing and a cleaning device. The housing is formed with a mounting space to be supplied with a pressurized cleaning fluid. The cleaning device includes a hollow nozzle retainer mounted in the mounting space, a particle-collecting pad mounted on the nozzle retainer, and a tubular nozzle. The nozzle includes a nozzle body having an inlet portion mounted to the nozzle retainer, and an outlet portion. The nozzle body extends through the particle-collecting pad such that the outlet portion is disposed outside the housing. The nozzle permits the pressurized cleaning fluid flowing into the mounting space to flow from the inlet portion through the outlet portion.

### BACKGROUND OF THE INVENTION

1. Field of the Invention

The invention relates to a cleaning apparatus, more particularly to a jet stream cleaning apparatus.

2. Description of the Related Art

In a drilling manufacturing process for a printed circuit board (PCB), such as drilling of micro vias like blind vias, buried vias, through vias, etc., the most common fabrication techniques are mechanical drilling and laser drilling. The fabrication technique to be employed depends on product requirements. At present, the mechanical drilling technique is more favored by most manufacturers. A mechanical drilling machine uses a high-speed rotating drill bit to drill micro vias of predetermined sizes in predetermined positions of printed circuit boards. The drilling manufacturing process as such is relatively simple and inexpensive.

During mechanical drilling, as a result of the cutting action on the printed circuit board by the drill bit, particulate matter will be generated and can accumulate on the drill bit as well as the drill chuck.

When a substantial amount of the particulate matter has accumulated between the drill chuck and the drill bit, the linear orientation as well as the smoothness of rotation of the drill bit cannot be ensured, which can result in deterioration in the quality and efficiency of drilling, thereby affecting the production efficiency. Therefore, operators must conduct cleaning operations to ensure the production efficiency. In the prior art, such cleaning operations typically include removal of the drill bit from the drill chuck, and removal of the particulate matter from the drill bit and the drill chuck by brushing.

The use of a pressurized air stream for cleaning drill chucks was not contemplated in the prior art, especially if the drill chuck has a blind hole configuration, for the following reason: When the pressurized air stream is directed from the outside of the drill chuck into the blind hole, some of the particulate matter will be moved deeper into the blind hole, which makes it more difficult to remove the same from the blind hole.

### SUMMARY OF THE INVENTION

Therefore, the object of the present invention is to provide a jet stream cleaning apparatus that can be extended into a blind hole in a tool so that a pressurized cleaning fluid can be directed to flow from an innermost end to an outermost end of the blind hole in the tool, thereby resulting in fast and effective removal of particulate matter that accumulated in the blind hole in the tool.

Accordingly, a jet stream cleaning apparatus of this invention comprises a housing and a cleaning device.

The housing is formed with a mounting space that is adapted to be supplied with a pressurized cleaning fluid.

The cleaning device includes a hollow nozzle retainer mounted in the mounting space, a particle-collecting pad mounted on one side of the nozzle retainer and exposed from the housing, and a tubular nozzle including a nozzle body having an inlet portion mounted to the nozzle retainer, and an outlet portion opposite to the inlet portion. The nozzle body extends through the particle-collecting pad such that the outlet portion is disposed outside the housing. The tubular nozzle permits the pressurized cleaning fluid flowing into the mounting space to flow from the inlet portion through the outlet portion.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of the first preferred embodiment of a jet stream cleaning apparatus according to the present invention;

FIG. 2 is a schematic sectional view to illustrate a cleaning device of the first preferred embodiment;

FIG. 3 is a schematic partly sectional view to illustrate the first preferred embodiment in a state of use;

FIG. 4 is a perspective view of the second preferred embodiment of a jet stream cleaning apparatus according to the present invention;

FIG. 5 is a fragmentary schematic sectional view to illustrate the second preferred embodiment in a state of use; and

FIGS. 6a to 6c are schematic views to illustrate consecutive cleaning stages that can be conducted with the use of the second preferred embodiment of this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

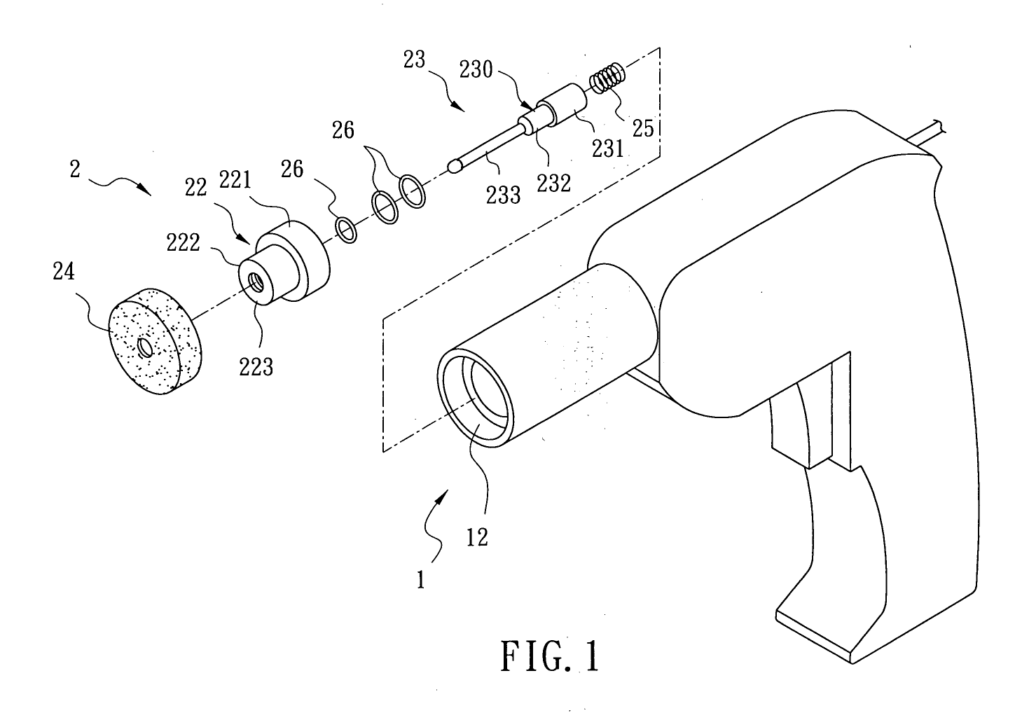

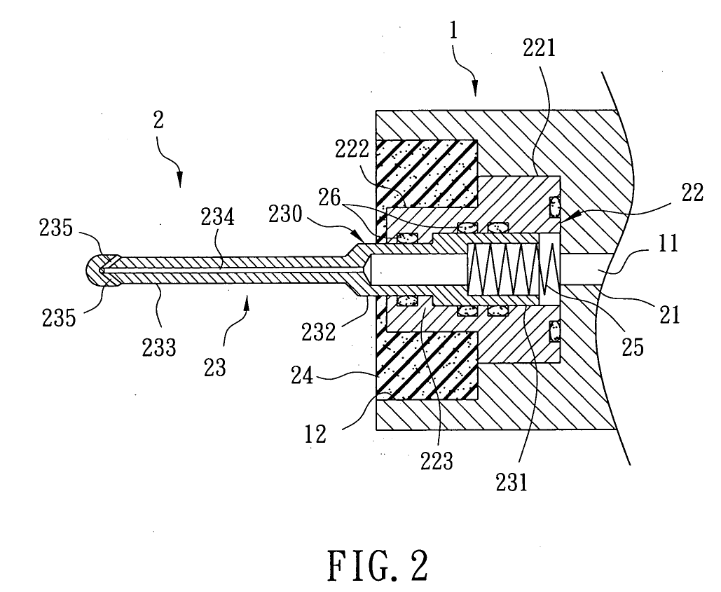

Referring to FIGS. 1 and 2, the first preferred embodiment of a jet stream cleaning apparatus according to the present invention is shown to be in the form of a spray gun that includes a housing 1 and a cleaning device 2.

The housing 1 is in the form of a gun housing that is designed to be gripped by hand, and has a barrel part formed with a mounting space 12 that is adapted to be supplied with a pressurized cleaning fluid 11. The housing 1 is further formed with a fluid intake conduit 21 in fluid communication with the mounting space 12 and adapted for guiding the pressurized cleaning fluid 11 into the mounting space 12. The flow of the pressurized cleaning fluid 11 into the mounting space 12 can be controlled in any known manner, such as with the use of a fluid valve (not shown). In this embodiment, the pressurized cleaning fluid 11 is a pressurized dry gas.

The cleaning device 2 includes a hollow nozzle retainer 22 mounted in the mounting space 12, a particle-collecting pad 24 (such as a sponge pad) mounted on one side of the nozzle retainer 22 and exposed from the housing 1, a tubular nozzle 23 movably retained by the nozzle retainer 22 and extending through the particle-collecting pad 24, an urging unit 25 mounted in the nozzle retainer 22 for providing a biasing force that acts on the nozzle 23, and at least one O-ring member 26 for establishing a fluid-tight seal between the nozzle retainer 22 and the nozzle 23.

The tubular nozzle 23 includes a nozzle body 230 having an inlet portion 231 mounted to the nozzle retainer 22, an outlet portion 233 opposite to the inlet portion 231, and a connecting portion 232 between the inlet portion 231 and the outlet portion 233. The urging unit 25 extends into the inlet portion 231. The nozzle body 230 extends through the particle-collecting pad 24 such that the outlet portion 233 is disposed outside the housing 1. The tubular nozzle 23 permits the pressurized cleaning fluid 11 flowing into the mounting space 12 to flow from the inlet portion 231 through the outlet portion 233. To this end, the nozzle body 230 is formed with an axial fluid passage 234 that extends from the inlet portion 231 to the outlet portion 233, and at least one nozzle orifice 235 that is formed in the outlet portion 233 and that is in fluid communication with the axial fluid passage 234. In this embodiment, the outlet portion 233 has a tip with an outer wall surface, and each nozzle orifice 235 extends from the axial fluid passage 234 to the outer wall surface of the tip of the outlet portion 233. In this embodiment, there is a plurality of nozzle orifices 235 that are spaced apart angularly with respect to the axial fluid passage 234. Each nozzle orifice 235 forms an angle with respect to the axial fluid passage 234, and extends from the axial fluid passage 234 in a direction toward the inlet portion

In this embodiment, the inlet portion 231 is mounted slidably to the nozzle retainer 22 and is movable toward and away from the housing 1. The urging unit 25, which is a compression spring in this embodiment, biases the nozzle body 230 away from the housing 1. The connecting portion 232 of the nozzle body 230 has a cross-section smaller than that of the inlet portion 231 and larger than that of the outlet portion 233.

In this embodiment, the nozzle retainer 22 includes an inner retainer part 221 and an outer retainer part 222 that extends from the inner retainer part 221 in a direction away from the housing 1 and that has a cross-section smaller than that of the inner retainer part 221. The outer retainer part 222 is formed with a radial inward stop ring 223. The connecting portion 232 of the nozzle body 230 extends slidably through the stop ring 223. The inlet portion 231 of the nozzle body 230 is movably confined by the inner and outer retainer parts 221, 222, and is prevented by the stop ring 223 from being undesirably removed from the nozzle retainer 22.

In this embodiment, there are three O-ring members 26, one of which establishes a fluid-tight seal between the stop ring 223 and the connecting portion 232 of the nozzle body 230, and the other two of which establish a fluid-tight seal between the nozzle retainer 22 and the inlet portion 231 of the nozzle body 230.

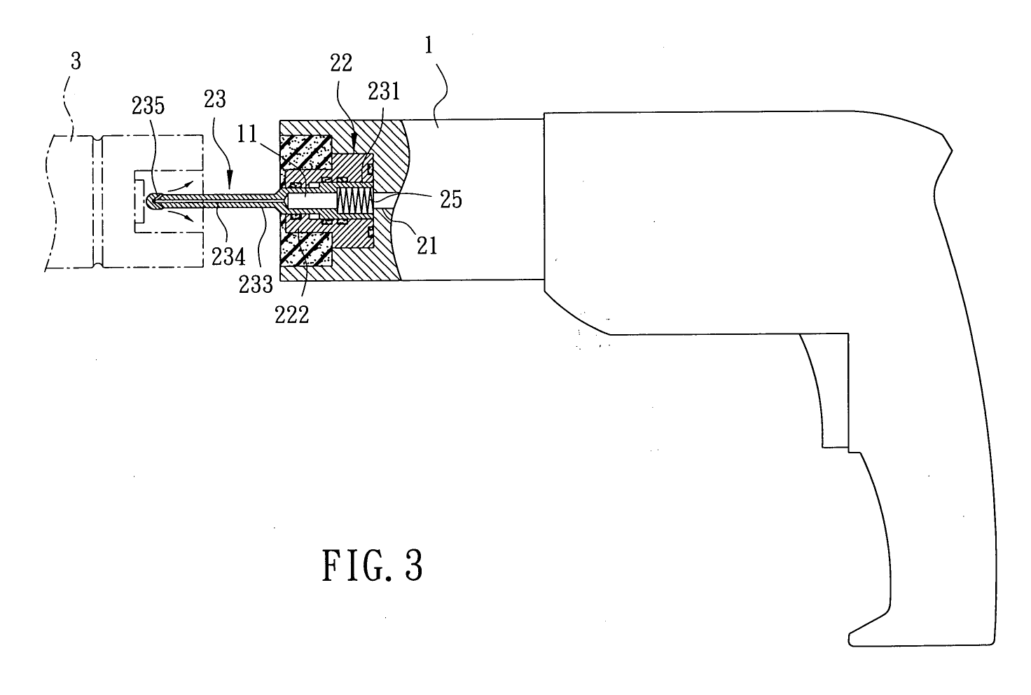

In use, as shown in FIG. 3, the housing 1 can be gripped so as to extend the tip of the outlet portion 233 of the nozzle body 230 into a blind hole in a tool 3 (such as a cigarette lighter) that is to be cleaned and so that the tubular nozzle 23 can be retracted into the nozzle retainer 22 against the biasing force of the urging unit 25. At this time, the pressurized cleaning fluid 11 can be controlled to flow into the mounting space 12 through the fluid intake conduit 21. Fluid flow control can be conducted manually or automatically. In particular, during manual control, a fluid valve (not shown) in the housing 1 is actuated manually when the tubular nozzle 23 is retracted into the nozzle retainer 22. On the other hand, during automatic control, the fluid valve (not shown) is actuated automatically upon detection by a sensor (not shown) that the tubular nozzle 23 has been retracted into the nozzle retainer 22.

The pressurized cleaning fluid 11 (in this case, the pressurized dry air) that flows into the mounting space 12 flows through the axial fluid passage 234 in the nozzle body 230 and exits the tubular nozzle 23 at the nozzle orifices 235. The pressurized cleaning fluid 11 that exits the nozzle orifices 235 blows toward a hole-confining wall of the blind hole in the tool 3 to generate fluid currents that sweep particulate matter from the hole-confining wall out of the blind hole in the tool 3 for subsequent collection on the particle-collecting pad 24.

Thereafter, when the tip of the outlet portion 233 of the nozzle body 230 is extracted from the blind hole in the tool 3, the tubular nozzle 23 is restored to its initial position by the biasing force of the urging unit 25. At this time, the flow of the pressurized cleaning fluid 11 into the mounting space 12 can be stopped either manually or automatically in the manner described hereinabove.

Depending on the condition inside the blind hole in the tool 3, the apparatus of the first preferred embodiment may be employed to conduct a series of cleaning operations by switching among different types of the pressurized cleaning fluids 11, thereby resulting in an optimum cleaning effect.

It has thus been shown that the fluid currents supplied by the jet stream cleaning apparatus of this embodiment not only sweep particulate matter from the hole-confining wall of the blind hole in the tool 3, but also remove the particulate matter from the blind hole in the tool 3.

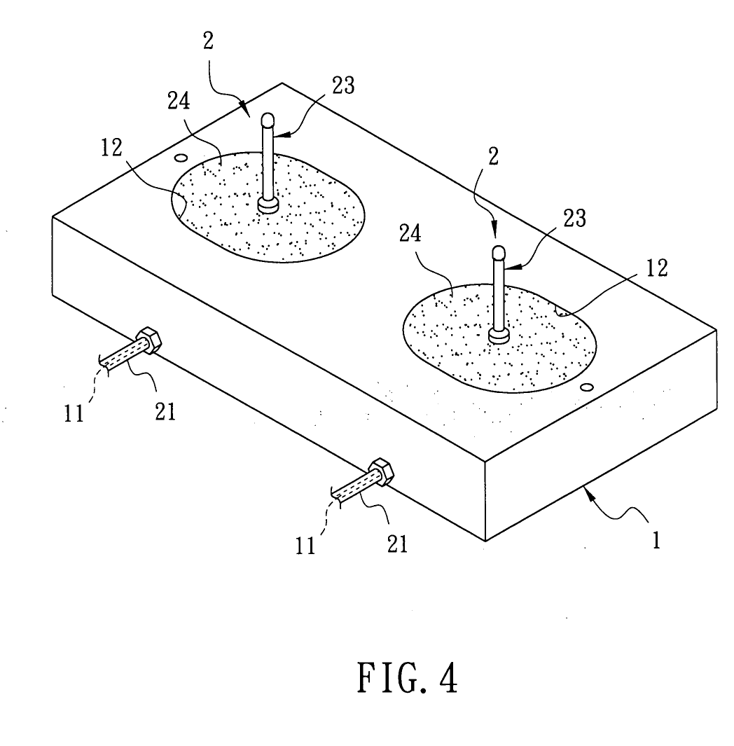

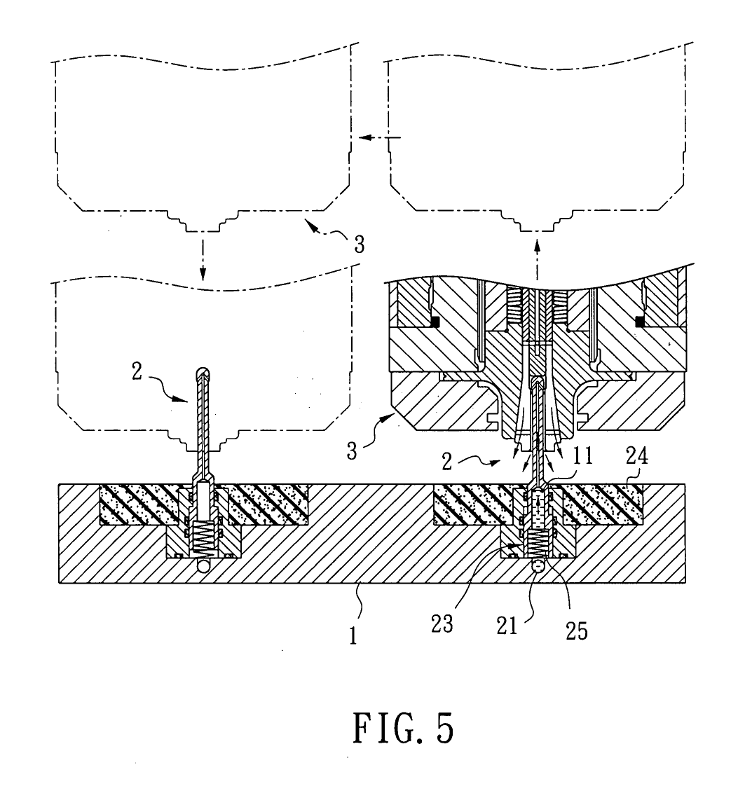

Referring to FIGS. 4 and 5, the second preferred embodiment of a jet stream cleaning apparatus according to this invention is shown to include a stationary machine housing 1 and a pair of cleaning devices 2 mounted on the housing 1. The housing 1 is formed with a pair of spaced apart and fluidly isolated mounting spaces 12. Each mounting space 12 is adapted to be independently supplied with a pressurized cleaning fluid 11 via a dedicated fluid intake conduit 21. In this embodiment, one of the mounting spaces 12 is supplied with pressurized dry gas for conducting a dry cleaning operation, whereas the other one of the mounting spaces 12 is supplied with pressurized cleaning liquid for conducting a wet cleaning operation.

Each of the cleaning devices 2 is mounted on the housing 1 at a respective one of the mounting spaces 12. Since each of the cleaning devices 2 has a construction similar to that described hereinabove in connection with the first preferred embodiment, further details of the same are omitted herein for the sake of brevity.

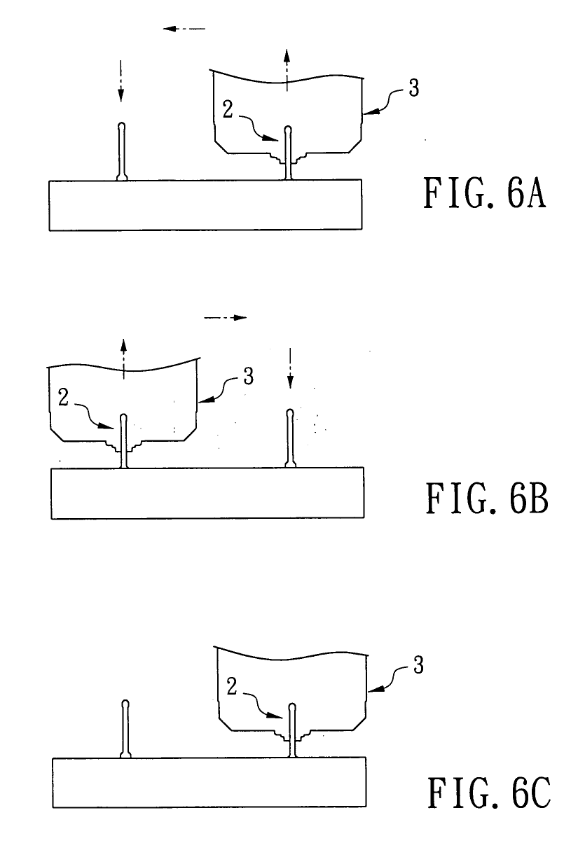

As shown in FIG. 5 and FIGS. 6a to 6c, the jet stream cleaning apparatus of this embodiment is adapted for cleaning a drill chuck used during mechanical drilling of a printed circuit board. In view of the two cleaning devices 2, the tool 3 (i.e., the drill chuck) can undergo a three-stage cleaning operation (i.e., dry−>wet−>dry) using the cleaning apparatus of this embodiment for removing particulate matter in a blind hole of the tool 3. In particular, as best shown in FIG. 6a, the tool 3 is initially cleaned using pressurized dry gas via one of the cleaning devices 2. Thereafter, as best shown in FIG. 6b, the tool 3 is moved to the other one of the cleaning devices 2 for cleaning using pressurized cleaning liquid. Finally, as best shown in FIG. 6c, the tool 3 is moved back to the first cleaning device 2 for further cleaning using the pressurized dry gas. After the three-stage cleaning operation, the tool 3 (i.e., the drill chuck) is ready for connection to a drill bit (not shown) for resuming mechanical drilling activity.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A jet stream cleaning apparatus comprising:
a housing formed with a mounting space that is adapted to be supplied with a pressurized cleaning fluid; and
a cleaning device including
a hollow nozzle retainer mounted in said mounting space,
a particle-collecting pad mounted on one side of said nozzle retainer and exposed from said housing, and
a tubular nozzle including a nozzle body having an inlet portion mounted to said nozzle retainer, and an outlet portion opposite to said inlet portion, said nozzle body extending through said particle-collecting pad such that said outlet portion is disposed outside said housing, said tubular nozzle permitting the pressurized cleaning fluid flowing into said mounting space to flow from said inlet portion through said outlet portion.

2. The jet stream cleaning apparatus as claimed in claim 1, wherein said nozzle body is formed with an axial fluid passage that extends from said inlet portion to said outlet portion, and at least one nozzle orifice that is formed in said outlet portion and that is in fluid communication with said axial fluid passage.

3. The jet stream cleaning apparatus as claimed in claim 2, wherein said outlet portion has a tip with an outer wall surface, said nozzle orifice extending from said axial fluid passage to said outer wall surface of said tip of said outlet portion.

4. The jet stream cleaning apparatus as claimed in claim 3, wherein said nozzle orifice forms an angle with respect to said axial fluid passage and extends from said axial fluid passage in a direction toward said inlet portion.

5. The jet stream cleaning apparatus as claimed in claim 1, wherein said inlet portion is mounted slidably to said nozzle retainer and is movable toward and away from said housing.

6. The jet stream cleaning apparatus as claimed in claim 5, wherein said cleaning device further includes an urging unit mounted in nozzle retainer for biasing said nozzle body away from said housing.

7. The jet stream cleaning apparatus as claimed in claim 6, wherein:
said nozzle body further has a connecting portion between said inlet portion and said outlet portion, said connecting portion having a cross-section smaller than that of said inlet portion and larger than that of said outlet portion,
said nozzle retainer including an inner retainer part and an outer retainer part that extends from said inner retainer part in a direction away from said housing and that has a cross-section smaller than that of said inner retainer part, said outer retainer part being formed with a radial inward stop ring,
said connecting portion extending slidably through said stop ring, said inlet portion being movably confined by said inner and outer retainer parts and being prevented by said stop ring from being undesirably removed from said nozzle retainer.

8. The jet stream cleaning apparatus as claimed in claim 7, wherein said cleaning device further includes at least one O-ring member for establishing a fluid-tight seal between said nozzle retainer and said nozzle body.

9. The jet stream cleaning apparatus as claimed in claim 1, wherein said housing is further formed with a fluid intake conduit in fluid communication with said mounting space and adapted for guiding the pressurized cleaning fluid into said mounting space.
